(19) United States
(12) Patent Application Publication
(10) Pub. No.: US 2010/0260088 A1
(43) Pub. Date: Oct. 14, 2010

(54) SYSTEM AND METHOD FOR PROVIDING MULTICAST AND BROADCAST SERVICE IN COMMUNICATION SYSTEM

(75) Inventor: Hyung-Joon Jeon, Gyeonggi-do (KR)

Correspondence Address: AMPACC Law Group, 3500 188th Street S.W., Suite 103, Lynnwood, WA, 98037, US

(73) Assignee: Posco ICT Co., Ltd., Pohang (KR)

(21) Appl. No.: 12/740,347

(22) PCT Filed: Oct. 29, 2008
(86) PCT No.: PCT/KR08/06382

§ 371 Date: Apr. 28, 2010

(30) Foreign Application Priority Data
Oct. 29, 2007 (KR) 10-2007-0108922

(51) Int. Cl. H04H 20/71

(52) U.S. Cl. 370/312

(57) ABSTRACT

A system and method for providing a Multicast and Broadcast service (MBS) in a wireless communication system including base station, mobile station providing the MBS, and a plurality of relay stations for providing relay path between the base station and the mobile station, the base station receives Relay Station's Basic Capability Negotiation Request (SBC-REQ) messages transmitted from the relay stations, checks a capability information included in the SBC-REQ messages, allocates resources to the mobile station and a relay station among the relay stations based on the capability information, and provides the MBS to the mobile stations using the allocated resources.

### TECHNICAL FIELD

The present invention relates to a communication system and, in particular, to a system and method for providing a fast Multicast and Broadcast service (MBS) without waste of resources in a multi-hop relay communication system.

### BACKGROUND ART

Many researches have been done for providing subscribers with communication services having various Quality of Service (QoS) requirements. Recently, Broadband Wireless Access (BWA) communication systems, as next generation communication systems, are developed in focusing on the mobility and guaranteed QoS without compromising high data rate.

The BWA communication systems are characterized by supporting high speed multimedia, e.g. MBS, as well as conventional voice and packet data services. Typically, communication system for providing MBS includes a transmitter, i.e. Base Station (BS), for broadcast/multicast information and a plurality of receivers, i.e. Mobile Stations (MS) for receiving the information broadcasted/multicasted from the BS.

The communication system for providing MBS divides its broadcast service area into multiple service zones and allocates at least one transmitter per service section such that the MSs located in a specific service zone receive the MBS data broadcasted/multicasted from the transmitter of the service zone. The communications system for providing MBS can be configured such that one transmitter controls other transmitters that are responsible for their individual service zones to provide the MBS data simultaneously.

In the meantime, the BWA communication system tends to be implemented with multi-hop relaying architecture with an increased number of BSs or Relay Stations (RS) that are configured to establish relay paths to the MSs for improving data rate and entire system throughput in a service zone.

For the multi-hop relay communication system, the BSs, RSs, and MSs within the same MBS zone are synchronized and then the MBS data are transmitted, and the BSs should be synchronized in network level.

In a case that the multi-hop relay communication system provides in a multi-BS access scheme for the MBS, all the BSs within the same MBS zone broadcast the MBS data at an identical position of a synchronized frame unlike the single-BS access scheme in which a single BS broadcasts the MBS data.

In a case that there is only one RS connection with the BS, i.e. a maximum hop count of the path between the BS and MS is 2, the RS reports its processing delay in unit of frame to the BS as a capability parameter in a basic capability request message. When an MBS data transmission is necessary, the BS first transmit the MBS data over a relay downlink as a pre-transmission, and then after processing delay, the BS and RS synchronously transmit the MBS data over an access link.

In a case that there are multiple RSs connecting with the BS in the MBS zone at various hop counts from the BS and/or with different processing delays, each RS report its processing delay in unit of frame to the BS as a capability parameter in a basic capability request message, and the BS determines the maximum cumulative delay of all RSs in the MBS zone based on their position in the tree and their individual processing delays. The BS then calculates each RSs cumulative delay and calculates a required waiting time for each RS based on the value of the maximum cumulative delay, and notifies each RS of its waiting time via a basic capability response message.

If the BS detects that the waiting time has changed for a specific RS, it may transmits an unsolicited response message to the RS to update its waiting time. When an MBS data transmission is necessary, the BS transmits the MBS data over the relay downlink as a pre-transmission maximum cumulative delay frames before transmitting the MBS data over the access link, and each RS in the MBS zone transmits the received MBS data over its relay downlink. Finally, once the BS has waited the maximum accumulative delay frames and each RS has waited its specified waiting time, the BS and RSs synchronously transmit the MBS data over the access links.

Meanwhile, when the multi-hop relay communication system transmits MBS data in multi-BS access scheme, the MBS data is transmitted to the RSs in unicast scheme and each MS can receive the MBS data from multiple MSs located in the same MBS zone so as to achieve macro diversity gain. In this case, since the MS receives the MBS data from multiple BSs, i.e. the MBS data is transmitted in multi-BS access scheme, the MBS data is relayed via all the RSs, despite there is no need to transmit the MBS data to all the RSs.

In other words, the conventional multi-hop relay communication system transmits such that the MBS data transmitted from a BS is relayed via RSs that are necessary the MBS data transmission and that are unnecessary the MBS data transmission to a specific MS, whereby the system resource are allocated the RSs that are unnecessary the MBS data transmission, resulting in waste of resource. Also, the conventional multi-hop relay communication system has a drawback in that, since the MBS data transmission is performed in consideration of the cumulative delays and required waiting times of the respective RSs, cumulative transmission and reception delays occur.

### DISCLOSURE OF INVENTION

### Technical Problem

In order to overcome the above problems of the prior art, the present invention provides a system and method for providing an MBS in a communication system.

Also, the present invention provides a system and method for providing an MBS in a multi-hop relay communication system.

Also, the present invention provides a system and method for providing an MBS in a multi-hop relay communication system including a plurality of relay stations by using a multi-BS access scheme.

### Technical Solution

According to one aspect of the present invention, there is provided a method for providing a multicast and broadcast service (MBS) at a base station in a wireless communication system including base station, mobile station providing the MBS, and a plurality of relay stations for providing relay path between the base station and the mobile station. The method includes receiving Relay Station's Basic Capability Negotiation Request (SBC-REQ) messages transmitted from the relay stations; checking a capability information included in the SBC-REQ messages, and allocating resources to the mobile station and a relay station among the relay stations based on the capability information; and providing the MBS to the mobile stations using the allocated resources.

According to another aspect of the present invention, there is provided a method for providing multicast and broadcast service (MBS) in a wireless communication system including base station, mobile station providing the MBS, and a plurality of relay stations for providing relay path between the base station and the mobile station. The method includes transmitting, at a relay station, a Relay Station's Basic Capability Negotiation Request (SBC-REQ) message to the base station; being allocated resources form the base station, at the relay station needed MBS data transmission in response to the SBC-REQ message; and providing, at the relay station, the MBS received from the base station to the mobile station using the allocated resources.

According to further another aspect of the present invention, there is provided a method for managing relay stations in a multi-hop relay network supporting a multicast and broadcast service (MBS) in a multi-base station access scheme. The method includes transmitting to a base station, at a relay station, a message including a capability information indicating whether MBS data transmission is necessary in accordance with preset status of the relay station; and transmitting, at the relay station, a MAP information received from the base station to mobile station or another relay station in accordance with the message, when the message includes the capability information indicating which the MBS data transmission is unnecessary.

According to yet another aspect of the present invention, there is provided a system for providing a multicast and broadcast service (MBS) in a wireless communication system. The system includes a base station; a mobile station supporting the MBS; and a plurality of relay stations providing relay links from the base station to the mobile station, wherein the base station receives Relay Station's Basic Capability Negotiation Request (SBC-REQ) messages from the relay stations, checks capability information included in the SBC-REQ message, allocates resources to the mobile station and a relay station among the relay stations based on the capability information; and the relay station provides the MBS provided from the base station to the mobile station using the allocated resources.

According to still another aspect of the present invention, there is provided a system for providing a multicast and broadcast service (MBS) in a wireless communication system. The system includes a base station; a mobile station supporting the MBS; and a plurality of relay stations providing relay links from the base station to the mobile station, wherein the relay stations each transmit Relay Station's Basic Capability Negotiation Request (SBC-REQ) messages to the base station, a relay station is allocated resources by the base station, wherein the relay station needed MBS data transmission among the relay stations based on the SBC-REQ messages, the mobile station is provided MBS from the base station via relay path providing the relay station allocated resources.

### ADVANTAGEOUS EFFECTS

The MBS provision method and system of the present invention allocates resources to relay stations in consideration of their capabilities in a communication system, thereby preventing waste of resources and reducing transmission and reception delay, resulting in fast MBS. Also, the MBS provision method and system of the present invention allocates resources to only the relay stations that are necessary to transmit MBS data so as to establish optimal relay links, thereby preventing waste of resources and reducing transmission and reception delays at the base and mobile stations.

### BRIEF DESCRIPTION OF THE DRAWINGS

The above and other aspects, features and advantages of the present invention will become more apparent from the following detailed description when taken in conjunction with the accompanying drawings in which:

FIG. 1 is a schematic diagram illustrating a communication system for providing MBS according to an embodiment of the present invention;

FIG. 2 is a flowchart illustrating a method for providing an MBS in BS's view according to an embodiment of the present invention

FIG. 3 is a schematic diagram illustrating a communication system for providing MBS according to another embodiment of the present invention;

FIG. 4 is a schematic diagram illustrating a communication system for providing MBS according to another embodiment of the present invention;

FIG. 5 is a schematic diagram illustrating a communication system for providing MBS according to another embodiment of the present invention; and

FIG. 6 is a schematic diagram illustrating a communication system for providing MBS according to another embodiment of the present invention.

### MODE FOR THE INVENTION

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

The present invention proposes a system and method for providing Multicast and Broadcast service (MBS) in a communication system, e.g. Broadband Wireless Access (BWA) communication system based on the Institute of Electrical and Electronics Engineers (IEEE) 802.16 standards. In order to help understanding the present invention, the present invention is described with an exemplary IEEE 802.16 standards-base communication system using Orthogonal Frequency Division Multiplexing (OFMD)/Orthogonal Frequency Division Multiple Access (OFDMA), however, the present invention is not limited thereto, but can be applied to other communication systems based on the evolutions of IEEE 802.16 standards to be rectified in the future.

Also, the present invention proposes a system and method for providing the MBS in a wireless communication system comprising a transmitter, e.g. Base Station (BS) for controlling a service zone of a wireless communication system and receivers provided the MBS from the BS, e.g. Mobile stations (MSs) having fixity/mobility. In the following description, the MBS provision system and method of the present invention is described with a communication system for providing MBS in which each MS is provided by at least one BS in a multi-BS access scheme.

Unlike the single-BS access scheme in which an MS is connected to a BS providing MBS, the multi-BS access scheme allows an MS to receive MBS data transmitted from multiple BSs, within the same MBS zone, and transmitted at an identical position of a synchronized frame, thereby achieving macro diversity gain. At this time, the MS identifies the MBS zone with reference to an MBS zone identifier (ID). The MBS zone is an area in which the same MBS flow is served with a Connection Identifier (CID) or a Security Association (SA), i.e. which can be provided the MBS. The MBS zone information is transmitted to the MSs via a Downlink Channel Descriptor (DCD) message. That is, the MBS zone can be defined as a group of BSs using the same CIDs and same SAs for providing MBS, i.e. for transmitting the same MBS data.

Also, in a multi-hop relay communication system including a plurality of Relay Stations (RSs) proving multi-hop relay paths according to the present invention, the system allocates resources to the RSs in consideration of their capabilities and finds optimal relay paths between the BSs and MSs, thereby improving service quality without waste of resources. In the following description, RSs transmits messages including their capabilities to the BS such that the BS checks the capabilities of the RSs and schedules MBS data transmission for providing the MSs with the MBS via RSs based on the capabilities.

In a case that multiple relay paths with plural RSs at various hop counts are established between the BS and MS, the BS receives processing delays of the RSs in unit of frame as a capability parameter and determines a maximum cumulative delay of all RSs in the MBS zone based on their positions in the tree and their individual processing delays. The BS then calculates the required waiting time for each RS based on the value of maximum cumulative delay and each RS's cumulative delay and notifies each RS of its waiting time via a response message. If the BS detects that the waiting time has changed for a particular RS, it may transmit an unsolicited response message to that RS to update its waiting time.

When an MBS data transmission is necessary, the BS transmits the MBS data over the relay downlink as a pre-transmission maximum delay frames before transmitting the MBS data over the access link. The RSs in the MBS zone transmit the MBS data received over the relay downlink. Finally, once the BS has waited maximum delay frames and each RS has waited its specified time, the BS and RSs synchronously transmit the MBS data over the access links.

In the case that multiple RSs providing relay links for paths between the BS and MS exist, i.e. multiple RSs establish relay links at various hop counts from the BS to the MS, the communication system according to an embodiment of the present invention determines the MBS data transmission time to the MS based on the maximum cumulative delay and each RS's cumulative delay and waiting time, and schedules MBS data transmission based on the RS's capabilities, and provides MBS to the MS. Particularly, when the RSs that are unnecessary for the MBS data transmission exist, e.g. the MS is not need to receive the MBS data via RSs but from more than one BS, the BS checks the information on the RSs (i.e. the information on whether the MBS data transmission of the RSs are necessary), allocates resources to the only the necessary RSs that are needed to participate in the MBS data transmission, and transmits the MBS data via the qualified RSs using the allocated resources in consideration of the cumulative delays and required waiting times of the qualified RSs, thereby reducing the transmission and reception delay and preventing waste of resources, resulting in fast MBS.

That is, in the communication system according to an embodiment of the present invention, the BS determines whether to provide the MBS via relay links, i.e. the BS perform resource scheduling in consideration of necessity of the RSs, and then transmits the MBS data to the MS. At this time, the BS allocates the resources to the RSs necessary for establishing relay links and transmits the MBS data to the MS via the necessary RSs. This prevents the resources from being allocated to the RSs unnecessary for the MBS data transmission, resulting in prevention waste of resource. Also, since the resources are allocated only for the necessary RSs, the MBS data is not relayed via unnecessary relay links but via optimal relay links, thereby reducing waiting time of the MS and providing fast MBS.

The RSs are classified into non-MBS RSs that are excluded for the MBS data transmission, static multi-BS MBS RSs that supports MBS data transmission in the static multi-BS MBS mode, and dynamic multi-BS MBS RSs that support the MBS data transmission in the dynamic multi-BS MBS mode. The RS that needs the MBS data transmission in the static multi-BS MBS mode supports the MBS data transmission regardless of the existence of destination MS such that the static multi-BS MBS RS is allocated the resource for establishing relay links and relays the MBS data using the resource. The RS that needs the MBS data transmission in the dynamic multi-BS MBS mode supports the MBS data transmission only when at least one destination MS exists such that the dynamic multi-BS MBS RS is allocated resource, when the destination MS is detected, and relays the MBS data using the resource. If the MS has stopped receiving the MBS data or handed over to another cell in the middle of receiving the MBS data from the RS transmitting MBS data in the dynamic multi-BS MBS mode, the resource allocated to the dynamic multi-BS MBS RS is released.

Whether the MBS data transmission of each RS is necessary, i.e. the RS configuration associated with the MBS data transmission, is determined based on the position of the RS within the MBS zone in the communication environment of the network at the initial system configuration stage, particularly, the MBS zone coverage established by the BS, macro diversity, and the positions of the RSs for supporting the MBS data transmission to the MS. For example, the RSs located at the boundary region of the MBS zone for expanding the MBS zone coverage, the RSs for serving the MSs located in the shade areas and coverage hole such as inside of and between buildings, the RSs deployed for serving the MSs inside buildings and mobile vehicles and temporarily expanding the MBS zone coverage, and the RSs deployed for increasing macro diversity are determined as the RSs that are needed to transmit MBS data, i.e. static multi-BS MBS RSs and/or dynamic multi-BS MBS RSs, and other RSs are determined as the RSs that are not need to transmit MBS data, i.e. non-MBS RSs. All the types of RSs report their capability information to the BS.

Each RS of which the MBS data transmission mode is determined in the initial network configuration transmits a Relay Station's Basic Capability Negotiation Request (SBC-REQ) message including its capability information to the BS or RS in initial connection procedure, or the BS transmits a Relay Station's Basic Capability Negotiation Response (SBC-RSP) message including the capability of each RS that is determined in the initial network configuration to the corresponding RS. The SBC-REQ and SBC-RSP messages are Media Access Control (MAC) messages that are exchanged between the BS and RSs through the capability negotiation process in the network entry procedure. The SBC-REQ and SBC-RSP messages include the RS capability information such as available modulation and coding scheme information and information indicating MBS data transmission necessity and the MBS data transmission mode for the RS. Here, MBS indication information includes Type Length Value (TLV) of the SBC-REQ/SBC-RSP message as shown in table 1.

TABLE 1

| Type | Length | Value | Scope |
|---|---|---|---|
| TBA | 1 | Bit#0: Static Multi-BS MBSBit#1: | SBC-REQ/ |
| | | Dynamic Multi-BS MBSBit#2-7: | SBC-RSP |
| | | Reserved | |

Table 1 shows an SBC-REQ/SBC-RSP message including information indicating the MBS data transmission necessary and the MBS data transmission mode. The SBC-REQ/SBC-RSP message includes an MBS data TLV of TBA (To Be Assigned) indicating MBS data transmission necessity of the RS in the RS's capability information. The first bit (#0) of the TLV, i.e. the Least Significant Bit (LSB) indicates that the RS transmitted the SBC-REQ/SBC-RSP message is necessary for transmitting MBS data in static multi-BS MBS mode, i.e. the RS can transmit the MBS data regardless of the existence of a destination MS. This bit can be checked as the information requesting MBS data transmission. The second bit (#1) of the TLV indicates that the RS transmitted the SBC-REQ/SBC-RSP message is necessary for transmitting MBS data in dynamic multi-BS MBS mode, i.e. the RS can transmit the MBS data when the destination MS exists. This bit can be checked as the information selectively requesting MBS data transmission.

In more detail, the one-byte long TLV of which the first and second bits (#0 and #1) are set to ‘0’ indicates the RS transmitted the SBC-REQ/SBC-RSP message is unnecessary for the MBS data transmission but the MBS-MAP Information Element (MBS-MAP IE), whereby the BS does not allocate resource to the RS for MBS data transmission.

The TLV of which the first bit (#0) is set to ‘1’ and the second bit (#1) is set to ‘0’ indicates that the RS transmitted the SBC-REQ/SBC-RSP message is necessary for the MBS data transmission in the static multi-BS MBS mode such that the RS can transmit the MBS data regardless of the existence of the destination MS. Accordingly, the BS allocates resources the BS such that the BS can always receive and transmit the MBS data and MAP messages including the MBS-MAP IEs.

In the meantime, the TLV of which the first bit (#0) is set to ‘0’ and the second bit (#1) is set to ‘1’ indicates that the RS transmitted the SBC-REQ/SBC-RSP message is necessary for the MBS data transmission in the dynamic multi-BS MBS mode such that the RS can selectively transmit the MBS data depending on the communication environment and whether the destination exists. For example, if an MS receiving the MBS data via the RS transmitting MBS data in the dynamic multi-BS MBS mode has stop receiving the MBS data or handed over to another cell such that no destination cell exists, the RS transmits a Dynamic Service Deletion Request (DSD-REQ) message to the BS and stops transmitting the MBS data. Meanwhile, there is at least one other destination MS entry is detected, the RS Dynamic Service Addition Request (DSA-REQ) message such that the RS is allocated resource to transmit the MBS data to the MS. The BS allocates the resource to the RS transmitting MBS data in the dynamic multi-BS mode and transmitted the SBC-REQ/SBC-RSP message and, if receiving the DSD-REQ message including the MBS data transmission termination information, releases the resource allocated for the MBS data transmission but maintains the resources for transmitting the MAP message including the MBS-MAP IEs. When there is at least one destination MS linked to the RS and the DSA-REQ message is received from the RS, the BS allocates the resource for the MBS data transmission to the RS such that the RS can transmit the MBS data and MAP messages including the MBS-MAP IEs.

Here the RS transmitting MBS data in the static multi-BS MBS mode can be of being temporarily installed for expanding MBS zone coverage in accordance with variation of the communication environment or installed in a tunnel or subway for supporting handover of MSs; and the RS transmitting MBS data in the dynamic multi-BS MBS mode can be of being installed at the boundary of the MBS zone for expanding the MBS zone coverage, installed in a shade area or a coverage hole for enhancing the MBS to the MSs inside a building and between buildings, installed inside buildings and mobile vehicle for expanding the MBS coverage, and installed for increasing macro diversity gain.

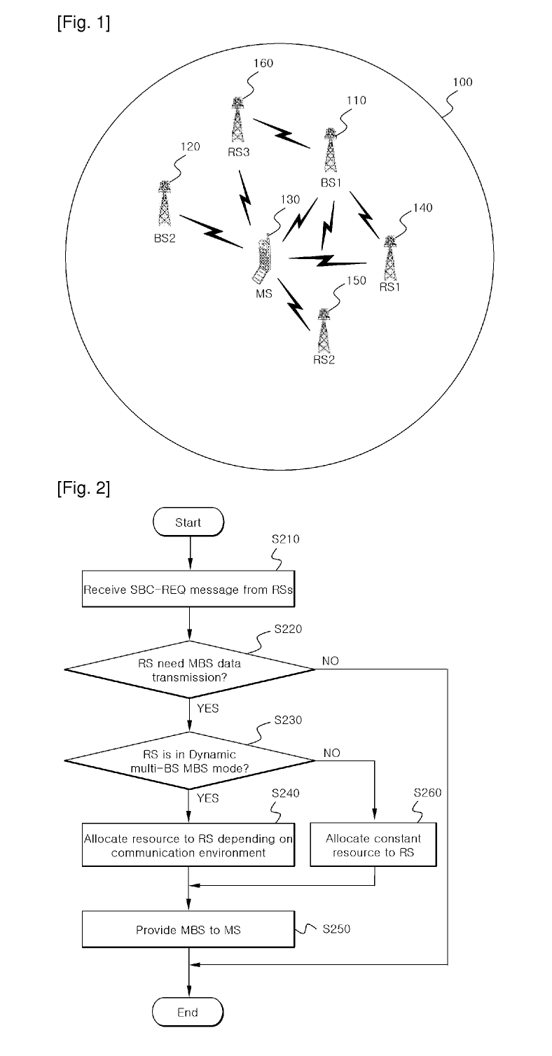

The communication system according to an embodiment of the present invention allocates resources to the RSs in consideration of their capabilities, i.e. MBS data transmission necessity and the MBS data transmission mode, whereby the resources are allocated to only the RSs that are currently necessary for MBS data transmission, resulting in prevention waste of resource. Since the RSs that are currently not necessary for MBS data transmission are not allocated the resources, they cannot activate relay links for MBS data transmission, whereby the network can provide optimal relay links of a path between the BS and MS, resulting in reduction of transmission delay of the BS and reception delay of the MS. Although the MBS provision system and method of the present invention is described with an exemplary case in which each RS transmits an SBC-REQ message carrying its capability to the BS in order to simplify the explanation, the present invention is not limited thereto. For example, the MBS provision system and method of the present invention can be implemented with a case in which the BS transmits an SBC-RSP message carrying the capability information of each RS within the MBS zone. Now, a structure and functions of a communication system for providing MBS are described in more detail with reference to FIG. 1.

FIG. 1 is a schematic diagram illustrating a communication system for providing MBS according to an embodiment of the present invention.

Referring to FIG. 1, the communication system includes plural BSs (i.e. BS1 110 and BS2 120) transmitting MBS data with a multi-BS access scheme, an MS 130 receiving the MBS data with the multi-BS access scheme from the BS and providing MBS, and a plurality of RSs (i.e. RS1 140, RS2 150, and RS3 160) that establish relay links for relaying the MBS data from the BSs 110 and 120 to the MS 130. Here, the RS1 140 is assumed as transmitting MBS data in the static multi-BS MBS mode in which the first and second bits (#0 and #1) in TLV of the SBC-REQ message transmitted from the RS are set to ‘1’ and ‘0’, respectively; the RS2 150 is assumed as transmitting MBS data in the dynamic multi-BS MBS mode in which the first and second bits (#0 and #1) in TLV included in the SBC-REQ message transmitted from the RS are set to ‘0’ and ‘1’, respectively; and the RS3 160 is assumed as transmitting MBS data in the non-MBS mode in which both the first and second bits (#0 and #1) of TLV included in the SBC-REQ message transmitted from the RS are set to ‘0’.

As aforementioned, each of the RSs 140, 150, and 160 transmits an SBC-REQ message including its capability to the BS1 110 in initial access procedure, and the BS1 110 received the SBC-REQ message checks the MBS data transmission mode of the RS transmitted the SBC-REQ message with reference to the TLV. From the checking results, the BS1 110 comes to know that the RS1 140 is necessary the MBS data transmission in the static multi-BS MBS mode, the RS2 150 is necessary the MBS data transmission in the dynamic multi-BS MBS mode, and the RS3 160 is unnecessary the MBS data transmission in non-MBS mode.

After checking the MBS data transmission of the RSs 140, 150, and 160, the BS1 110 performs scheduling to allocate resources to the RSs 140, 150, and 160, i.e. generating a downlink (DL) subframe (not shown) for transmitting MBS data. The DL subframe includes a preamble zone, a Frame Control Header (FCH) zone, a MAP zone, and a burst zone.

The preamble zone includes synchronization information for acquiring synchronization among the BS1 110, MS 130, and RSs 140, 150, and 160, i.e. preamble sequence is transmitted. The FCH zone includes basic information on the subchannels, ranging, modulation scheme, and the like. The MAP zone is used to transmit MAP message including MAP information, i.e. includes a downlink (DL)-MAP zone and an uplink (UL)-MAP zone. The DL-MAP zone carries a DL-MAP message including DL-MAP information, and the UL-MAP zone carries a UL-MAP message including UL-MAP information. The DL-MAP message includes MAP information having MBS-MAP Information Elements (MBS-MAP IEs), i.e. DL-MAP information, and the MBS-MAP IEs include information on burst regions allocated for transmitting the MBS data.

As described above, the BS1 110 checks the capacities of the RSs 140, 150, and 160 from the SBC-REQ messages, i.e. the BS1 110 checks the TLVs of the SBC-REQ messages transmitted from the RSs 140, 150, and 160 and recognizes the RS1 140 transmitting MBS data in the static multi-BS MBS mode (i.e. RS transmitting MAP information having MBS-MAP IEs and MBS data as RS always necessary for the MBS data transmission), the RS2 150 transmitting MBS data in the dynamic multi-BS MBS mode (i.e. RS transmitting MAP information having MBS-MAP IEs and MBS data as RS necessary for the MBS data transmission according to the communication environment), and the RS3 160 non-transmitting MBS data in the non-MBS mode (i.e. RS unnecessary the MBS data transmission).

After checking the capabilities of the RSs, the BS1 110 performs scheduling on the basis of the RSs' capabilities to allocate the resources to the RS1 140 and RSs2 150 for transmitting MBS data but not to the RS3 160. That is, the BS1 110 allocates a burst region for transmitting the MBS data from the BS1 100 to the MS 130, a burst region for transmitting the MBS data from the RS1 140 to the MS 130, and a burst region for transmitting the MBS data from the RS2 150 to the MS 130. Also, the BS1 110 allocates a burst region for transmitting the MBS data from the BS1 110 to the RS1 140 and a burst region for transmitting the MBS data from the BS1 110 to the RS2 150.

The MBS data is transmitted using the burst regions such that the MS 130 receives the MBS data from the respective BS1 110, RS1 140, and RS2 150. The MS 130 also receives the MAP message including the MBS-MAP IEs via the respective BS1 110, RS1 140, RS2 150, and RS3 160.

As described above, if the MS 130 receiving the MBS data from the BS1 110 hands over to another cell or stops receiving the MBS data, the RS2 150 transmitting MBS data in the dynamic multi-BS MBS mode transmits the BS1 110 a DSD-REQ message including MBS data transmission termination information. Upon receipt of the DSD-REQ message, the BS1 110 releases the resource allocated to the BS2 150 for relaying the MBS data. At this time, the BS1 110 determines that the RS2 150 is unnecessary for relaying the MBS data to the MS 130, so as not to allocate the burst region for the RS2 150. In this case, the RS2 150 can relay the MAP message including the MBS-MAP IEs like the RS3 160. If receiving a request for the MBS from the MS 130, the RS2 150 transmits a DSA-REQ message to the BS1 110. Upon receipt of the DSA-REQ message, the BS1 110 allocates a burst region for the RS2 150 to relay the MBS data.

In this manner, the BS1 110 receives the SBC-REQ messages including the capability information from the RSs 140, 150, and 160 and performs resource scheduling based on the capability information of the SBC-REQ messages. That is, the BS1 110 checks the MBS necessities of the RSs 140, 150, and 160 with reference to the TLVs of the SBC-REQ messages, allocates resources to the RS1 140 and RS2 150 but not the RS3 160 based on the checking results, thereby preventing the resource from being allocated to the MBS-unnecessary RS. In this case, the RS3 160 non-transmitting MBS data in the non-MBS mode can relay only the MAP message including the MBS-MAP IEs, whereby the cumulative delay and required waiting time of the RS3 is not needed to be considered when transmitting the MBS data. This reduces the MBS data transmission delay of the BS1 110 and the MBS data reception delay of the MS 130, resulting in fast MBS.

Although the MBS provision method is described with an exemplary case in that the BS1 110 allocates resources with reference to the SBC-REQ messages transmitted from the RSs 140, 150, and 160 for providing the MBS to the MS 130, the BS2 120 can receive the SBC-REQ messages and allocate resources for providing the MBS to the MS 130 in the same manner as the BS1 110. That is, the MS 130 can be provided from the BS1 110 and BS2 120 in the multi-BS MBS mode. The operations of a BS in the communication system according to an embodiment of the present invention are described hereinafter in more detail with reference to FIG. 2.

FIG. 2 is a flowchart illustrating a method for providing an MBS at BS in the communication system according to the embodiment of the present invention.

Referring to FIG. 2, a BS receives SBC-REQ messages from RSs located within the MBS zone in which the BS providing MBS at step S210. Here, the SBC-REQ messages are received through the capability negotiation process in the network entry procedure. After receiving the SBC-REQ messages, the BS checks the capability information included in each SBC-REQ message, i.e. the TLV of the SBC-REQ message (see table 1), and checks the necessity of the MBS data transmission and the MBS data transmission mode of the RS transmitted the SBC-REQ message at steps S220 and S230.

In more detail, the BS checks the first and second bits (#0 and #1) in the TLV of the SBC-REQ message and determines the RS transmitted the SBC-REQ message including the TLV of which both the first and second bits are set to ‘0’ as RS non-transmitting MBS data in a non-MBS, the RS transmitted the SBC-REQ message including the TLV of which the first bit is set to ‘1’ and the second bit is set to ‘0’ as RS transmitting MBS data in a static multi-BS MBS mode, and the RS transmitted the SBC-REQ message including the TLV of which the first bit is set to ‘0’ and the second bit is set to ‘1’ as RS transmitting MBS data in a dynamic multi-BS MBS mode.

If it has been determined that the RS is a RS transmitting MBS data in the dynamic multi-BS MBS mode at step S230, the BS allocates resource appropriate for the RS transmitting MBS data in the dynamic multi-BS MBS mode at step S240. In more detail, the BS allocates the resource appropriated for the RS transmitting MBS data in the dynamic multi-BS MBS mode such that the resource allocated to the RS can be released when the MS receiving the MBS data from the RS hands over to another cell or stops receiving the MBS data. As described above, when the MBS data transmission is not required, the RS transmitting MBS data in the dynamic multi-BS MBS mode transmits a DSD-REQ message requesting termination of the MBS data transmission to the BS. After allocating the resource to the RS, the BS provides the MBS to the MS via the RS using the resource at step S250.

If it has been determined that the RS is RS transmitting MBS data in a static multi-BS MBS mode at step S230, the BS allocates resource appropriate for the RS transmitting MBS data in the static multi-BS MBS mode such that the RS can relay the MBS data regardless of the communication environment at step S260. After allocating the resource to the RS, the BS provides the MBS to the MS through the resource at step S250.

As described above, the BS checks the capability information of the RSs located within its MBS zone from the SBC-REQ messages transmitted from the RSs, i.e. the necessity of the MBS data transmission and the MBS data transmission modes of the RSs, and allocates resources to the RS depending on variation informed through the DSD-REQ message, whereby the resource are allocated to only the RSs necessary for the MBS data transmission.

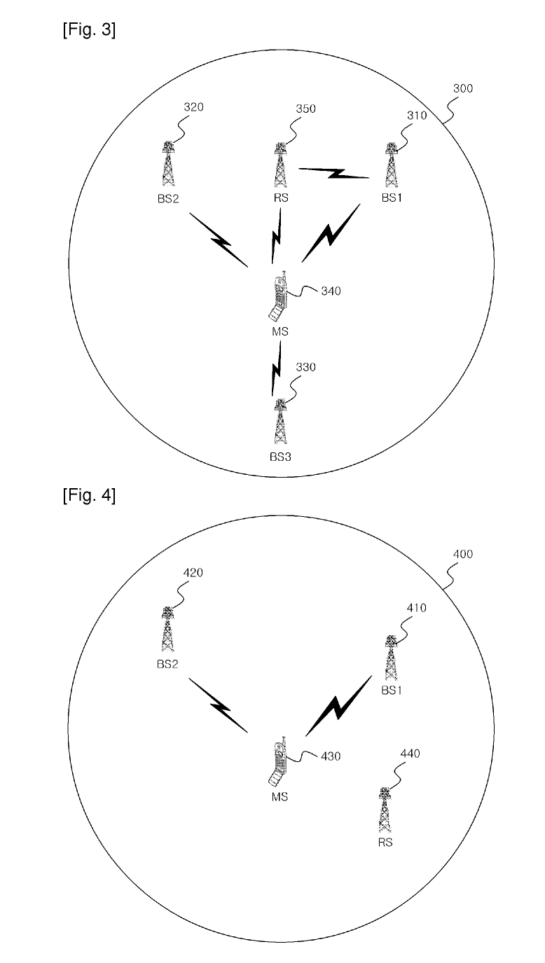

The MBS provision method according to this embodiment does not allocate resource to the RSs that are not necessary for the MBS data transmission, thereby preventing waste of resource. Since the resources are not allocated to the RSs unnecessary for the MBS data transmission, there is no need to consider the cumulative delays and waiting times of those RSs, thereby reducing the BS's transmission delay and MS's reception delay, resulting in provision of seamless MBS. A structure and functions of a communication system for providing MBS according to another exemplary embodiment of the present invention is described hereinafter with reference to FIG. 3.

FIG. 3 is a schematic diagram illustrating a communication system for providing MBS according to another embodiment of the present invention.

Referring to FIG. 3, the communication system includes plural BSs (BS1 310, BS2 320, and BS3 330) that transmit the MBS data in the multi-BS access scheme within the same MBS zone, an MS 340 that receives the MBS data transmitted from the BSs 310, 320, and 330 in the multi-BS access scheme, and an RS 350 that provides relay links from the BS1 310 to the MS 340. In order to simply the explanation, it is assumed that the channel environments between the MS 340 and the BSs 310, 320, and 330 are good enough to achieve macro diversity gain such that the RS 340 is not required for the MBS data transmission, i.e. both the first and second bits (#0 and #1) in the TLV of the SBC-REQ message transmitted from the RS 340 are set to ‘0’.

As aforementioned, the RS 350 transmits an SBC-REQ message including its capability information to the BS1 310 through the capability negotiation process in the network entry procedure, and the BS1 310 received the SBC-REQ message checks the TLV of the SBC-REQ message (see table 1) to check that the RS 350 is unnecessary for MBS data transmission.

The BS1 310 performs resource scheduling and transmits the MBS data based on the checking result. At this time, since the RS 350 does not transmit MBS data in the non-MBS mode, the BS1 310 transmits the MBS data through an access link to the MS 340 and transmits a MAP message including MBS-MAP IEs to the MS 340 via relay links provided from the RS 350. Accordingly, the MS 340 receives the MBS data from the BSs 310, 320, and 330 in the multi-BS access scheme and receives the MBS burst information, i.e. the MAP message including the MBS-MAP IEs, via the RS 350.

In this embodiment, since the MBS data is transmitted from multiple BSs 310, 320, and 330 in the multi-BS access scheme, the MS 340 can achieve macro diversity gain. Also, since the MBS data is not transmitted to the RS 350 non-transmitting MBS data in the non-MBS mode, there is no need to allocate resource for transmitting the MBS data but the MAP message including the MBS-MAP IEs, resulting in prevention waste of resource. Since the RS 350 is configured to relay only the MAP message including the MBS-MAP IEs, there is no need to consider the cumulative delay and waiting time of the RS 350 for the MBS data transmission, thereby reducing MBS data transmission delay at the BS1 310 and MBS data reception delay at the MS 340, resulting in fast MBS. A structure and functions of a communication system for providing MBS according to another embodiment of the present invention are described hereinafter with reference to FIG. 4.

FIG. 4 is a schematic diagram illustrating a communication system for providing according to another embodiment of the present invention.

Referring to FIG. 4, the communication system includes plural BSs (BS1 410 and BS2 420) that transmit in the multi-BS access scheme within the same MBS zone, an MS 430 that receives the MBS data transmitted from the BSs 410 and 420 in the multi-BS access scheme, and an RS 440 that provides relay links from the BS1 410 to the MS 430. In order to simplify explanation, it is assumed that the channel environments between the MS 430 and the BSs 410 and 420 are good enough to achieve macro diversity gain, and the RS 440 is a transparent RS which doesn't transmit the MBS data and MAP message or just relays the MBS data and MAP message transmitted from the BS1 410 to the MS 430, i.e. both the first and second bits (#0 and #1) in the TLV of the SBC-REQ message transmitted from the RS 440 are set to ‘0’.

As aforementioned, the RS 440 transmits an SBC-REQ message including its capability information to the BS1 410 through the capability negotiation process in the network entry procedure, and the BS1 410 received the SBC-REQ message checks the TLV of the SBC-REQ message (see table 1) to check that the RS 440 is unnecessary for MBS data transmission.

The BS1 410 performs resource scheduling and transmits the MBS data based on the checking result. At this time, since the RS 440 does not transmit MBS data in the non-MBS mode, the BS1 410 transmits the MBS data through an access link to the MS 430, whereas the BS1 410 transmits a MAP message including the MBS-MAP IEs as well as the MBS data to the RS 440. Accordingly, the MS 430 receives the MBS data from the BSs 410 and 420 in the multi-BS access scheme and receives the MBS burst information, i.e. the MAP message including the MBS-MAP IEs, from the BS1 410.

In this embodiment, since the MBS data is transmitted from both the BSs 410 and 420 in the multi-BS access scheme, the MS 430 can achieve macro diversity gain. Also, since the MBS data and the MAP message including the MBS-MAP IEs are not transmitted to the transparent RS 440, there is no need to allocate resource for transmitting the MAP message as well as the MBS data, resulting in prevention waste of resource and protection of unnecessary relay link establishment. Accordingly, there is no need to consider the cumulative delay and waiting time of the RS 440 for the MBS data transmission, thereby reducing MBS data transmission delay at the BS1 410 and MBS reception delay at the MS 430. A structure and functions of a communication system for providing MBS according to another embodiment of the present invention are described hereinafter with reference to FIG. 5.

FIG. 5 is a schematic diagram illustrating a communication system for providing MBS according to another embodiment of the present invention.

Referring to FIG. 5, the communication system includes plural BSs (BS1 510 and BS2 520) that transmit in the multi-BS access scheme within the same MBS zone 500, an MS 530 that receives the MBS data transmitted from the BSs 510 and 520 in the multi-BS access scheme, and multiple RSs (RS1 540 and RS2 550) that provide relay links from the BS1 510 to the MS 530. In order to simplify the explanation, it is assumed that the RS1 540 and RS2 550 are non-transparent RSs that receive and reprocess the MBS data and MAP message transmitted from the BS1 510 depending on communication environment, e.g. generate a new MAP message, and transmits the reprocessed MBS data and MAP message to the MS 530; and the RS1 540 transmits MBS data in the static or dynamic multi-BS MBS mode for the MBS data transmission, i.e. one of the first and second bits (#0 and #1) in the TLV of the SBC-REQ message transmitted from the RS1 540 is set to ‘1’, and the RS2 550 does not transmit MBS data in the non-MBS mode, i.e. both the first and second bits (#0 and #1) in the TLV of the SBC-REQ message transmitted from the RS2 550 are set to ‘0’.

As aforementioned, each of the RSs 540 and 550 transmits an SBC-REQ message including its capability information to the BS1 510 through the capability negotiation process in the network entry procedure, and the BS1 510 received the SBC-REQ messages checks the TLVs of the SBC-REQ messages (see table 1) to check the necessities of the MBS data transmission and the MBS data transmission modes of the RSs 540 and 550. From the checking results, the BS1 510 finds that the RS1 540 transmits MBS data in static or dynamic multi-BS MBS mode and the RS2 550 does not transmit MBS data in non-MBS mode based on the TLVs of the SBC-REQ messages.

After checking the necessities of the MBS data transmission and the MBS data transmission modes of the RSs 540 and 550, the BS1 510 performs resource scheduling to transmit the MBS data based on the checking results. That is, the BS1 510 allocates the resource for MBS data transmission to the RS1 540 since it is the non-transparent RS transmitting MBS data in the static or dynamic multi-BS MBS mode, but does not allocate the resource for MBS data transmission to the RS2 550 since it is the non-transparent RS does not transmit MBS data in the non-MBS mode. The RS1 540 receives and reprocesses the MBS data and burst information, i.e. the MAP message including the MBS-MAP IEs, transmitted from the BS1 510 and transmits the reprocessed MBS data and MAP message to the MS 530. In the meantime, the RS2 550 receives and reprocesses the MAP message transmitted from the RS1 540 depending on the communication environment and then transmits the reprocessed MAP message to the MS 530. In this case, the MS 530 receives the MBS data from the BSs 510 and 520 and RS1 540 in the multi-BS access scheme and the MAP message including the MBS-MAP IEs from the RSs 540 and 550.

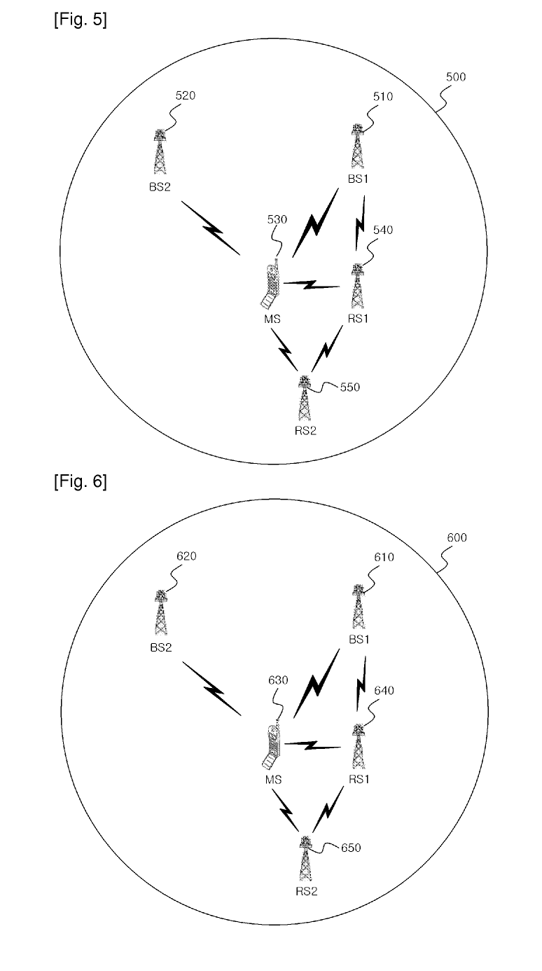

In this embodiment, since the MBS data is transmitted from the BSs 510 and 520 and the RS1 540 in the multi-BS access scheme, the MS 530 can achieve the MBS data with macro diversity gain. Also, the resource for MBS data transmission is allocated to only the non-transparent RS1 540 transmitting MBS data in the static or dynamic multi-BS MBS mode but not to the non-transparent RS2 550 non-transmitting MBS data in the non-MBS mode, resulting in prevention waste of resource. For this reason, there is no need to consider the cumulative delay and waiting time of the RS2 550 for MBS data transmission, thereby reducing MBS data transmission delay at the BS1 510 and MBS reception delay at the MS 530, resulting in fast MBS. Furthermore, since the non-transparent RSs 540 and 550 reprocesses the MBS data and/or the MAP message and transmit the reprocessed MBS data and the MAP message to the MS 530, reception rate of signal further increases. A structure and functions of a communication system for providing MBS according to another embodiment of the present invention are described hereinafter with reference to FIG. 6.

FIG. 6 is a schematic diagram illustrating a communication system for providing MBS according to another embodiment of the present invention.

Referring to FIG. 6, the communication system includes plural BSs (BS1 610 and BS2 620 that transmit in the multi-BS access scheme within the same MBS zone 600, an MS 630 that receives the MBS data transmitted from the BSs 610 and 620 in the multi-BS access scheme, and multiple RSs (RS1 640 and RS2 650) that provide relay links form the BS1 610 to the MS 630. In order to simplify the explanation, it is assumed that the RS1 640 is a non-transparent RS that receives and reprocesses the MBS data and MAP message transmitted from the BS1 610 and transmits MBS data in the static or dynamic multi-BS MBS mode (i.e. one of the first and second bits (#0 and #1) in the TLV of the SBC-REQ message transmitted from the RS 610 is set to ‘1’), and the RS2 is an RS belonged to a virtual RS group consisting of a plurality of transparent and non-transparent RSs that are not required for the MBS data transmission (i.e. both the first and second bits (#0 and #1) in the TLV of the SBC-REQ message transmitted from the RS2 are set to ‘0’).

As aforementioned, each of the RSs 640 and 650 transmits an SBC-REQ message including its capability information to the BS1 610 through the capability negotiation process in the network entry procedure, and the BS1 received the SBC-REQ messages checks the TLVs of the SBC-REQ messages (see table 1) to check the necessities of the MBS data transmission and the MBS data transmission modes of the RSs 640 and 650. From the TLV checking results, the BS1 610 finds that the RS1 640 is necessary the MBS data transmission in the static or dynamic multi-BS MBS mode and the RS2 is unnecessary the MBS data transmission in the non-MBS mode.

After checking the necessities of the MBS data transmission and the MBS data transmission modes of the RSs 640 and 650, the BS1 610 performs resource scheduling to transmit the MBS data based on the checking results. That is, the RS1 610 allocates the resource for MBS data transmission to the RS1 640 since it transmits MBS data in the static or dynamic multi-BS MBS mode as the non-transparent RS but does not allocate the resource for MBS data transmission for the RS2 since it does not transmit MBS data in the non-MBS mode regardless of its transparency, i.e. whether it is a transparent RS or a non-transparent RS. The RS1 640 receives and reprocesses the MBS data and burst information, i.e. the MAP message including the MBS-MAP IEs, transmitted from the BS1 610 depending on the communication environment and transmits MAP message to the MS 630 and transmits the reprocessed MAP message to the RS2 650. The RS2 650 transmits the MAP message received from the RS1 to the MS 630. In this case, the MS 630 receives the MBS data from the BSs 610 and 620 in the multi-BS access scheme and the RS1 640 and the MAP message including the MBS-MAP IEs from the BS1 610 and RSs 640 and 650.

In this embodiment, since the MBS data is transmitted from the BSs 610 and 620 and the RS1 640 in the multi-BS access scheme, the MS 630 can receive the MBS data with macro diversity gain. Also, the resource for MBS data transmission is allocated to only the non-transparent RS1 640 transmitting MBS data in the static or dynamic multi-BS MBS mode but not to the RS2 non-transmitting MBS data in the non-MBS mode, resulting in prevention waste of resource. For this reason, there is no need to consider the cumulative delay and waiting time of the RS2 for MBS data transmission, thereby reducing MBS data transmission delay at the BS1 610 and MBS reception delay at the MS 630, resulting in fast MBS. Furthermore, since the non-transparent RSs 640 and 650 reprocess the MBS data and the MAP message and/or the MAP message and transmit the reprocessed MBS data and/or the MAP message to the MS 630, the reception diversity gain further increases.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A method for providing a multicast and broadcast service (MBS) at a base station in a wireless communication system including base station, mobile station providing the MBS, and a plurality of relay stations for providing relay path between the base station and the mobile station, comprising:
receiving Relay Station's Basic Capability Negotiation Request (SBC-REQ) messages transmitted from the relay stations;
checking a capability information included in the SBC-REQ messages, and allocating resources to the mobile station and a relay station among the relay stations based on the capability information; and
providing the MBS to the mobile stations using the allocated resources.

2. The method of claim 1, wherein the capability information is information indicating whether MBS data transmission of the relay station is necessary.

3. The method of claim 2, wherein the step of allocating resources allocates resource to the relay station, when the capability information of the relay station indicates necessity of the MBS data transmission.

4. The method of claim 1, wherein the capability information is information indicating whether MBS data transmission of the relay station is a static multi-base station MBS mode or a dynamic multi-base station MBS mode.

5. The method of claim 4, wherein the static multi-base station MBS mode is a mode in which the relay station transmits MBS data always regardless of the mobile station.

6. The method of claim 4, wherein the dynamic multi-base station MBS mode is a mode in which the relay station transmits MBS data selectively in accordance with the mobile station.

7. The method of claim 4, wherein the step of allocating resources receives a Dynamic Service Addition Request (DSA-REQ) message from the relay station, and allocates the resource to the relay station in response to the DSA-REQ message, when the MBS data transmission of the relay station is the dynamic multi-base station MBS mode.

8. The method of claim 4, wherein further comprising:
receiving a Dynamic Service Addition Request (DSA-REQ) message from the relay station after allocating the resources, and releasing the resource in response to the DSD-REQ, when the MBS data transmission of the relay station is the dynamic multi-base station MBS mode.

9. The method of claim 8, wherein the reception of the DSD-REQ message receives from the relay station when the mobile station receiving MBS data via the relay station hands over to a neighbor cell or stops receiving the MBS data.

10. The method of claim 4, wherein the dynamic multi-base station MBS mode is set for at least one of relay stations which are installed for expanding a coverage of an MBS zone defined by the base station, providing relay links at a shadow area in the MBS zone, increasing macro diversity within the MBS zone.

11. The method of claim 1, wherein the capability information is determined based on a communication environment of the relay station within an MBS zone defined by the base station.

12. The method of claim 1, wherein the step of providing the MBS to the mobile station comprises transmitting a MAP message including information for the allocated resources to the relay and mobile station.

13. A method for providing multicast and broadcast service (MBS) in a wireless communication system including base station, mobile station providing the MBS, and a plurality of relay stations for providing relay path between the base station and the mobile station, comprising:
transmitting, at the relay station, a Relay Station's Basic Capability Negotiation Request (SBC-REQ) message to the base station;
being allocated, at the relay station needed MBS data transmission in response to the SBC-REQ message, resources by the base station; and
providing, at the relay station, the MBS provided by the base station to the mobile station using the allocated resources.

14. The method of claim 13, wherein the step of transmitting SBC-REQ message transmits a capability information indicating whether the MBS data transmission of the relay station is necessary.

15. The method of claim 13, wherein the step of transmitting SBC-REQ message transmits a capability information indicating whether the MBS data transmission of the relay station is a static multi-base station MBS mode or a dynamic multi-base station MBS mode.

16. The method of claim 15, wherein the static multi-base station MBS mode is a mode in which the relay station transmits MBS data always regardless of the mobile station.

17. The method of claim 15, wherein the dynamic multi-base station MBS mode is a mode in which the relay station transmits MBS data selectively in accordance with the mobile station.

18. The method of claim 15, wherein the step of being allocated resources comprising:
transmitting a Dynamic Service Addition Request (DSA-REQ) message to the base station and being allocated the resource from the base station in response to the DSA-REQ message, when the MBS data transmission of the relay station is the dynamic multi-base station MBS mode.

19. The method of claim 15, wherein further comprising:
transmitting a Dynamic Service Deletion Request (DSD-REQ) message to the base station after being allocated the resources, and being released the resource in response to the DSD-REQ, when the MBS data transmission of the relay station is the dynamic multi-base station MBS mode.

20. The method of claim 19, wherein the transmission of the DSD-REQ message is performed when the mobile station receiving MBS data using the allocated resources hands over to a neighbor cell or stops receiving the MBS data.

21. The method of claim 15, wherein the dynamic multi-base station MBS mode is set for at least one of relay stations which are installed for expanding a coverage of an MBS zone defined by the base station, providing relay links at a shadow area in the MBS zone, increasing macro diversity within the MBS zone.

22. The method of claim 13, wherein the SBC-REQ message includes a capability information of the relay station, and the capability information is determined based on a communication environment of the relay station within an MBS zone defined by the base station.

23. A system for providing a multicast and broadcast service (MBS) in a wireless communication system, comprising:
a base station;
a mobile station supporting the MBS; and
a plurality of relay stations providing relay links from the base station to the mobile station,
wherein the base station receives Relay Station's Basic Capability Negotiation Request (SBC-REQ) messages from the relay stations, checks capability information included in the SBC-REQ message, allocates resources to the mobile station and a relay station among the relay stations based on the capability information; and the relay station provides the MBS provided from the base station to the mobile station using the allocated resources.

24. The system of claim 23, wherein the capability information is information indicating whether MBS data transmission of the relay station is necessary.

25. The system of claim 24, wherein the base station allocates a resource to the relay station for the MBS data transmission, when the capability information of the relay station indicates necessity of the MBS data transmission.

26. The system of claim 23, wherein the capability information is information indicating whether MBS data transmission of the relay station is a static multi-base station MBS mode or a dynamic multi-base station MBS mode.

27. The system of claim 26, wherein the static multi-base station MBS mode is a mode in which the relay station transmits MBS data always regardless of the mobile station.

28. The system of claim 26, wherein the dynamic multi-base station MBS mode is a mode in which the relay station transmits MBS data selectively in accordance with the mobile station.

29. The system of claim 28, wherein the relay station transmits a Dynamic Service Deletion Request (DSD-REQ) message to the base station, when the mobile station receiving the MBS data via the relay station hands over to a neighbor cell or stops receiving the MBS data in the dynamic multi-base station MBS mode.

30. The system of claim 26, wherein the dynamic multi-base station MBS mode is set for at least one of relay stations which are installed for expanding a coverage of an MBS zone defined by the base stations, providing relay links at a shadow area in the MBS zone, increasing macro diversity within the MBS zone.

31. A method for managing relay stations in a multi-hop relay network supporting a multicast and broadcast service (MBS) in a multi-base station access scheme, comprises:
transmitting to a base station, at a relay station, a message including a capability information indicating whether MBS data transmission is necessary in accordance with preset status of the relay station; and
transmitting, at the relay station, a MAP information received from the base station to mobile station or another relay station in accordance with the message, when the message includes the capability information indicating which the MBS data transmission is unnecessary.

32. The method of claim 31, wherein the message further includes information indicating which the MBS data transmission is selectively necessary.

33. The method of claim 31, wherein the relay station is a non-transparent type relay station.
